(19) United States
(12) Patent Application Publication
(10) Pub. No.: US 2024/0144188 A1
(43) Pub. Date: May 2, 2024

(54) SYSTEM FOR TRACKING PERSONNEL CONTENT ENGAGEMENT AND RETENTION

(71) Applicant: Cerkl, Inc., Blue Ash, OH (US)

(72) Inventors: Rachel Ann Folz, Wyoming, OH (US); Samuel Jarrett Huber, Maineville, OH (US); Tarek Kamil, Fort Thomas, KY (US); Madeline Rose Rieman, Cincinnati, OH (US); Scott David Eble, Milford, OH (US); Kyle Thomas Johnson, Loveland, OH (US); Anthony Joseph Conte, Maineville, OH (US)

(21) Appl. No.: 18/243,490

(22) Filed: Sep. 7, 2023

Related U.S. Application Data
(60) Provisional application No. 63/404,351, filed on Sep. 7, 2022.

(51) Int. Cl. G06Q 10/105

(52) U.S. Cl. CPC G06Q 10/105

(57) ABSTRACT

A system is configured to track and provide objective behavioral data of employees based upon an employee's engagement with communications, resources, tools, and other content distributed via an organization's information systems and software. This behavioral data may be combined into an employee profile that includes employee demographic and employment information and may be analyzed by an artificial intelligence or expert function to provide a quantitative metric that describes the likelihood that the employee will depart an organization during an upcoming time period. A dashboard is provided that summarizes and visualizes quantitative metrics and other employee information and provides tools for creating a retention plan for particular employees. When selecting actions for a retention plan, an employee profile is updated to reflect the action and re-analyzed to provide a quantitative metric describing the net effect of the action on employee retention.

This application claims priority to U.S. Provisional Patent Application No. 63/404,351, filed Sep. 7, 2022, which is incorporated by reference herein in its entirety.

### FIELD

The disclosed technology pertains to a system for tracking personnel engagement with distributed content and managing retention of personnel based thereon.

### BACKGROUND

Personnel related costs are a substantial portion of operational costs for most organizations. Some obvious personnel related costs include salary, wages, and other benefits provided to personnel by an organization. Other less obvious personnel related costs include the cost of recruiting and hiring, training costs (e.g., direct costs, but also lost productivity attributable to new personnel settling in and becoming fully productive over time), post-termination costs (e.g., severance payments, as well as cost and risk associated with post-termination disputes), and other less tangible costs associated with loss of irreplaceable institutional knowledge and experience (e.g., such as the loss of a long-tenured database administrator whose familiarity with the peculiarities of an organization's information systems often allowed for quick resolution and/or avoidance of problems).

With substantial portions of personnel related costs occurring post-termination (e.g., both the post-termination costs described above, as well as the loss of pre-termination investments in the personnel's training, certification, and other aspects that are not retained by the organization after termination), it is no surprise that many organizations invest significant time and effort into identifying and retaining valuable personnel. Conventional approaches to personnel retention include processes like performance reviews, exit reviews, promotions, salary adjustments, team and culture building exercises, personnel surveys and other solicitation of feedback, and other activities. While these conventional approaches can be effective, in many cases there are still gaps in information and other weaknesses that are not easily resolved.

As an example, performance reviews, surveys, and other personnel feedback opportunities can be useful, but only if the personnel provides complete and accurate responses. Non-anonymized survey responses and personnel feedback provided during performance reviews are typically considered to be low quality and/or unreliable as they relate to the personnel's satisfaction with their role, since a personnel's subjective responses in such a scenario will often be influenced by their awareness of a current or future observer of the responses. As a result, even where a particular personnel is considering leaving a role, they will rarely volunteer that information even if particularly asked in a survey or during a performance review. Another weakness of these conventional processes and approaches is that they are slow moving. For example, a performance review or similar process might be conducted annually, and promotions, salary adjustments and other retention efforts typically occur annually. While surveys might be conducted more frequently, there is always a risk that a high frequency or high volume of surveys will result in lower participation rates, or lower quality of participation, by respondents.

While some conventional software and technologies exist in the field of human resources and personnel management, their capabilities are generally limited to more basic aspects of personnel management and do not address the procedural and technical challenges of collecting quantitative and objective information relating to personnel satisfaction and retention. As a result, an organization using conventional personnel management platforms will often discover a retention problem after it is already too late to address, or will attempt to address a retention problem in way that doesn't resolve the core issue (e.g., such as raising the salary of an at-risk personnel, when the personnel is actually considering leaving their role due to organization culture issues).

What is needed, therefore, is an improved system for tracking and managing the retention of personnel.

### BRIEF DESCRIPTION OF THE DRAWINGS

The drawings and detailed description that follow are intended to be merely illustrative and are not intended to limit the scope of the invention as contemplated by the inventors.

FIG. 1 is a schematic diagram of an exemplary system configured to track personnel retention based on content engagement.

FIG. 2 is a flowchart of a set of high-level steps that could be performed with a system to track personnel retention based on content engagement

FIG. 3 is a flowchart of a set of steps that could be performed with a system to receive and organize content events.

FIG. 4 is a flowchart of a set of steps that could be performed with a system to create and maintain one or more models for analyzing retention.

FIG. 5 is a flowchart of a set of steps that could be performed with a system to create and manage personnel retention plans.

FIG. 6A is a screenshot of a global retention tracking interface.

FIG. 6B is a screenshot of a retention plan tracking interface.

FIG. 6C is a screenshot of a group retention tracking interface.

FIG. 6D is a screenshot of a retention risk summary interface.

FIG. 6E is a screenshot of a turnover rate interface.

FIG. 6F is a screenshot of a geographical retention risk interface.

FIG. 6G is a screenshot of a personnel interface.

FIG. 6H is a screenshot of an assigned task interface.

FIG. 6I is a screenshot of a retention plan management interface.

### DETAILED DESCRIPTION

The inventors have conceived of novel technology that, for the purpose of illustration, is disclosed herein as applied in the context of tracking content engagement and personnel retention. While the disclosed applications of the inventors' technology satisfy a long-felt but unmet need in the art of tracking content engagement and personnel retention, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only and should not be treated as limiting.

Implementations of the disclosed technology address technological and other limitations of conventional approaches to personnel communication and retention by providing quantitative metrics that are used to predict departure, provide guidance for intervention, and provide various user interface visualizations, features, and other tools. As has been described, surveys, performance reviews, and other forms of soliciting feedback from personnel provide subjective and often inaccurate results, and so are an unreliable source for predicting departure and guiding intervention. Implementations of the disclosed technology produce quantitative metrics by gathering behavioral data that describes the manner in which an individual interacts with content, communications, and other resources distributed by an organization. This behavioral data may be gathered unobtrusively and is difficult to fake or influence with subjective feedback, and may also be gathered continuously (e.g., as opposed to surveys, performance reviews, or other subjective metrics which generally occur infrequently, and so provide a snapshot of a prior time).

Behavioral data for a particular individual may be organized (e.g., such as one or more time-indexed sequences of events), combined with other data describing the individual and received from a human resource management system (“HRMS”), and analyzed by one or more artificial intelligence functions (e.g., machine learning, neural network), expert functions, or other trained or configured data analysis functions to provide quantitative metrics describing that individual's engagement and retention. As an example, such data analysis models and functions may include default or global models (e.g., a model configured for use with any organization or personnel), organization specific models (e.g., a model configured and customized for use with all personnel at a particular organization), and organization specific sub-models (e.g., a model configured and customized for use with a particular division, group, or other subset of personnel at a particular organization).

The quantitative metrics produced by the system are used to provide organization facing dashboards and other user interfaces that include data visualizations, automated alerts, and intervention focused tools such as retention plan and task creation and tracking. In some implementations, the system is configured to provide further quantitative metrics related to a retention plan by utilizing the similar or same models used to produce the initial quantitative metrics for an individual (e.g., where a retention plan includes a salary increase or promotion, the individual's input dataset may be modified and reprocessed to provide further quantitative metrics indicating the impact of a salary increase or promotion on retention). In this manner, a user of the system may both identify at-risk personnel based on quantitative metrics and receive guidance to create an intervention plan that will reduce the risk of that personnel departing based on quantitative metrics. As will be understood, the disclosed technology may be implemented in various settings and for purposes beyond tracking engagement and retention of personnel (e.g., tracking student engagement with a course, tracking patient engagement with a doctor's directions, etc.). However, in the interest of clarity, the systems, methods, and features described herein will be discussed in the context of employees engaged by an employer.

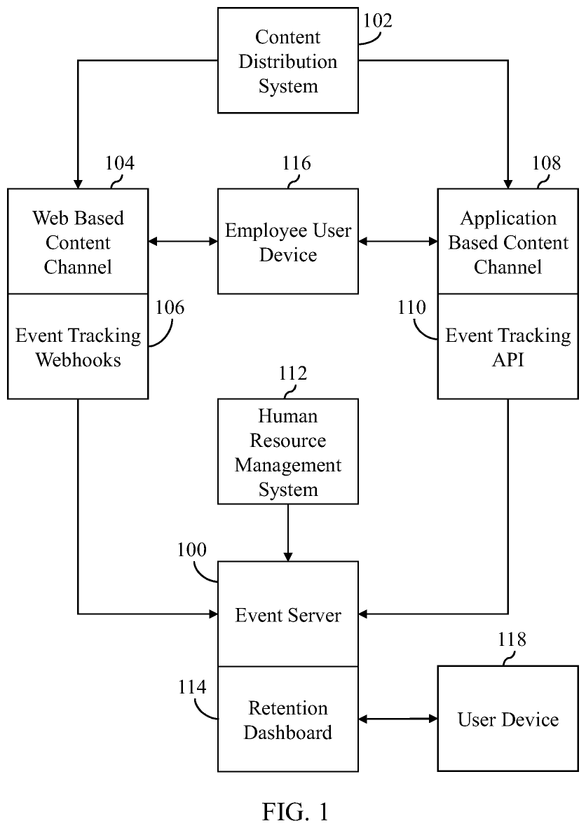

Turning now to the figures, FIG. 1 is a schematic diagram of an exemplary system configured to track personnel retention based on content engagement. An event server (100) may include one or more physical virtual, cloud, or other servers or server environments, each server (e.g., as well as other computing devices or user devices described herein) including one or more processors, memories, storage devices, communication devices, user interface devices, and other components of computing devices as may be useful or necessary in receiving, transmitting, storing, modifying, and analyzing data.

The event server (100) is configured to receive information including behavioral data related to employees in the form of discrete event datasets that each describe an employee action or omission related to an organization's electronic communications, content, resources, tools, and other features made available via the organization's information technology systems (e.g., the preceding more generally referred to as “content” herein), configured to produce quantitative metrics, alerts, and other automated activity based thereon, and configured to provide a retention dashboard (114) and other user interfaces to user devices (118) (e.g., a smartphone, computer, tablet computer, or other computing device) of users of the system.

The event server (100) may also be in communication with a HRMS (112) or other similar system of an organization or employer for which an instance of the event server (100) is configured. Data received from the HRMS (112) will vary by implementation and features, but as an example may include personal information (e.g., name, age, gender, and other descriptive or demographic information), employment information (e.g., position or role, group or subdivision, manager, hire date, salary, cost of replacement), and status information (e.g., an indication that the employee has resigned or was terminated, past records of engagement with the employee such as dates and results of reviews, stay interviews, exit interviews, etc.).

The system also includes a content distribution system (102) that is configured to publish and distribute content to some or all users of an organization's information systems and software. In varying implementations, the content distribution system (102) may be an independent system or server, may be part of the HRMS (112), or may be part of the event server (100). Content may be distributed by the system (102) to various channels, such as a web-based content channel (104) and an application-based content channel (108). Each content channel type (104, 108) refers to any application, platform, service, software, or other channel or interface that is configured to receive and display content to an employee user device (116) (e.g., a smartphone, computer, tablet computer, or other computing device), and so may include browser based or application based channels, and as an example may include e-mail, instant messaging and chat, team productivity and communication platforms (e.g., Microsoft Teams, Microsoft Sharepoint), employee specific content feeds or streams, and other channels.

Where content channel types (104, 108) differ is in their capabilities and/or the manner in which events are detected and reported to the event server (100). Application based content channels (108) support direct interaction via an event tracking API (110) that allows event data to be pushed or pulled to the event server (100). The event tracking API (110) may be integrated in the application based content channel (108) (e.g., such as a team productivity software that supports remote requests for data, or that is configured to push data to a remote source) such that the occurrence of particular events and user interactions causes an event dataset to be received by the event server (100) via the event tracking API (110).

Web based content channels (104) support web-based event tracking via event tracking webhooks (106) or other web-based hooks that are configured to detect the occurrence of events, and report event datasets to the event server (100). In some cases, a channel may be implemented as a web-based content channels (104) because it does not include or support an event tracking API (110), while in other cases such an API may be supported but it may be simpler or more advantageous to instead rely upon web-based event tracking webhooks (106). Event tracking webhooks (106) will vary by implementation and based upon specific channels, but for example may include tracking pixels inserted into distributed content, cookies or other web activity tracking technologies placed when accessing and interacting with content, structured URL parameters and attributes, client-side scripts, and other code, objects, resources, tools, or functions that can be embedded in or otherwise delivered with content. In varying implementations, event tracking webhooks (106) may be added to content by the content distribution system (102), or the content distribution system (102) may be configured to distribute content through the event server (100), and the event tracking webhooks (106) may be added at that time.

The content of event datasets reported by event tracking functions (106, 110) will vary by implementation, but for example may include a unique content identifier identifying a piece of content, a unique employee identifier identifying an employee, time and date that the event occurred, time and date that the content was first distributed, time between distribution and event, a device identifier identifying an employee user device (116) associated with the event, a content type, tag, or category describing or classifying the type of content, and an event type, category, or description that describes or classifies the event.

Event types may include, for example, events indicating a piece of content was opened or accessed (e.g., an email was opened and read, a link was clicked to load a website or application based viewer), events indicating the extent to which sub-content or sub-portions of a greater body of content are viewed or interacted with (e.g., the extent or depth to which a user scrolled downwards to view a sequence of sub-portions of content provided by a web or application based content feed or wall, user interactions with sub-portions of content such as clicking a menu link to jump to a particular sub portion, clicking a software control to expand and/or view further information on a sub portion, clicking a “thumbs up” button or other button to respond to the content, submitting a comment or other message in response to the content), and other event types. Since the system is configured to track and produce quantitative metrics based on engagement, the actual substance of the employee event may be disregarded, and need not be tracked or reported in an event dataset (e.g., where a particular employee clicks “thumbs down” on a piece of content, the event dataset may indicate that the employee clicked a feedback button, but need not indicate that it was the “thumbs down” button).

Events received by the event server (100) are associated with individual employees as quantitative metrics describing content engagement and may be used over time as input to an analytics model or function to produce further quantitative metrics describing employee retention as a factor of content engagement. Quantitative metrics, event data, information from the HRMS (112), and other data are used to populate and provide the retention dashboard (114) to users. In addition to providing text descriptions and visualizations of such data, the retention dashboard (114) may be configured to allow users to view information for single employees, organize employees into groups and view information for groups of employees, create, assign, and manage plans and tasks related to improving employee retention, and simulate the impact of retention tasks and actions on individual employees or groups of employees.

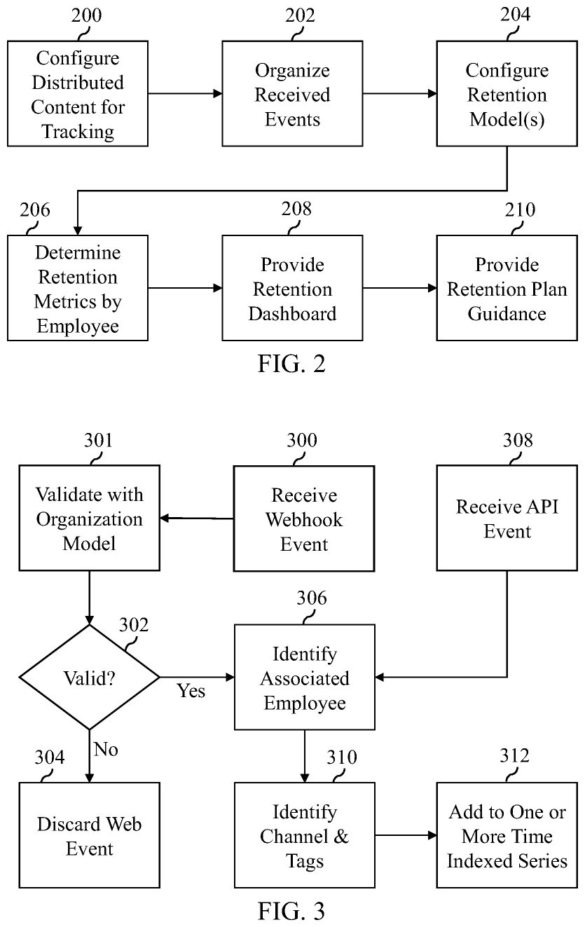

FIG. 2 is a flowchart of a set of high-level steps that could be performed with a system to track employee retention based on content engagement. Content may be configured (200) to support tracking (e.g., by the content distribution system (102), event server (100), or another device such as a client device). As has been described, this may include configuring event tracking APIs (110) or event tracking webhooks (106) to detect and report user engagement and interaction with content distributed across one or several channels. This may also include configuring the fields within event datasets that are reported to the event server, as well as ensuring that values for those fields are added and tracked throughout delivery of content, engagement with content, and reporting of an event (e.g., the content distribution system (102) may be configured to append an employee identifier to a tracking pixel or reference URL as content is delivered to each employee's web based content channel (104), so that the employee identifier can be subsequently passed to the event server (100) within an event dataset).

The event server (100) may also be configured to organize (202) events as they are received, which may include associating each event with a relevant employee, associating each event with a time index, or with one or more-time sequences, and filtering invalid events. The event server (100) may also configure (204) and maintain one or more retention models and functions that are usable to analyze an employee dataset of events and employee information to determine a quantitative metric for retention. As has been described, this may include training and/or configuring one or several artificial intelligence functions, expert functions, or other functions to analyze employee events and other information and determine, within the context of that organization or a sub-portion of that organization, a quantitative retention metric describing how likely the employee is to leave their position. The event server (100) may also use the configured (204) models to determine (206) quantitative retention metrics for some or all of the employees.

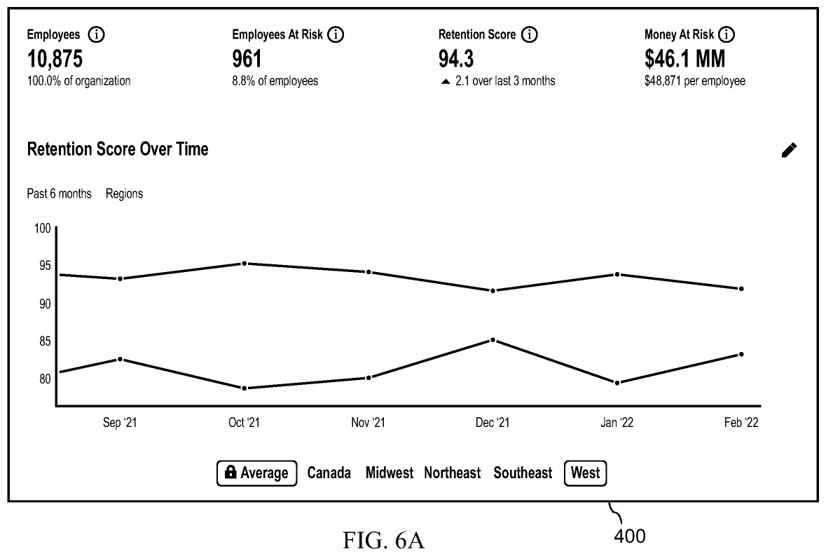

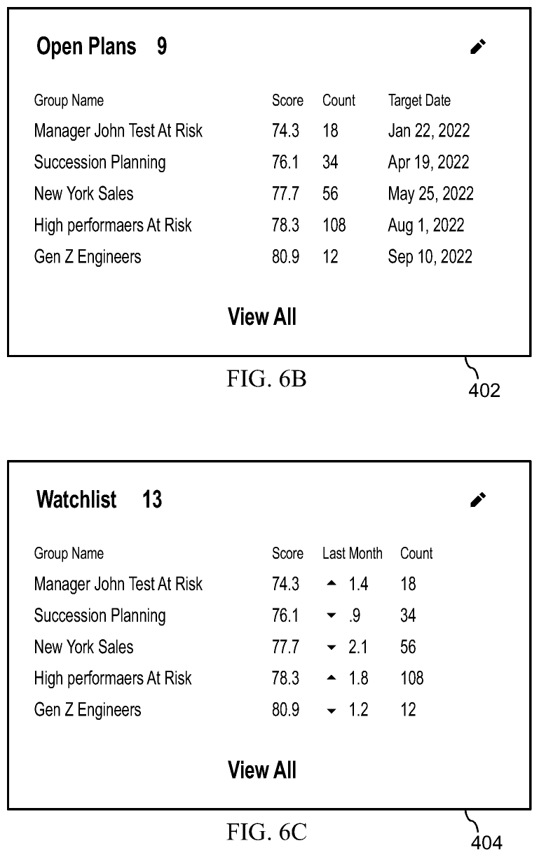

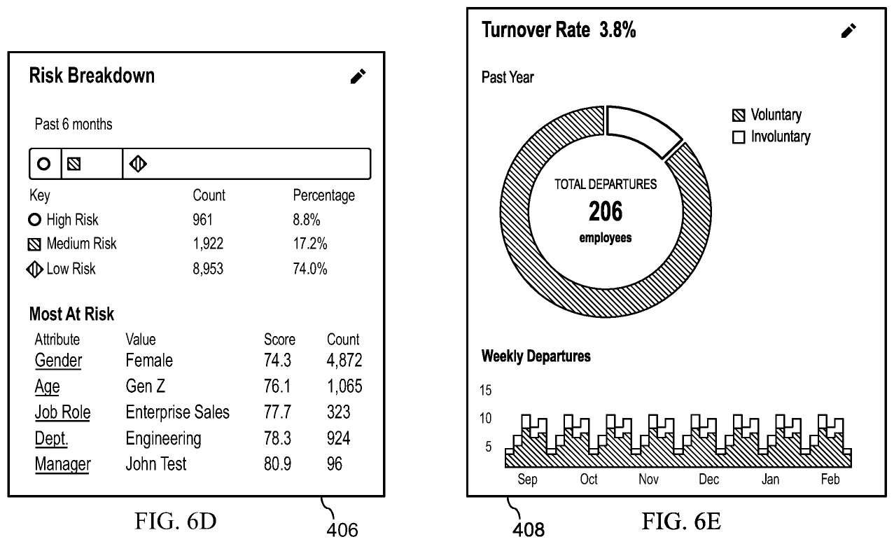

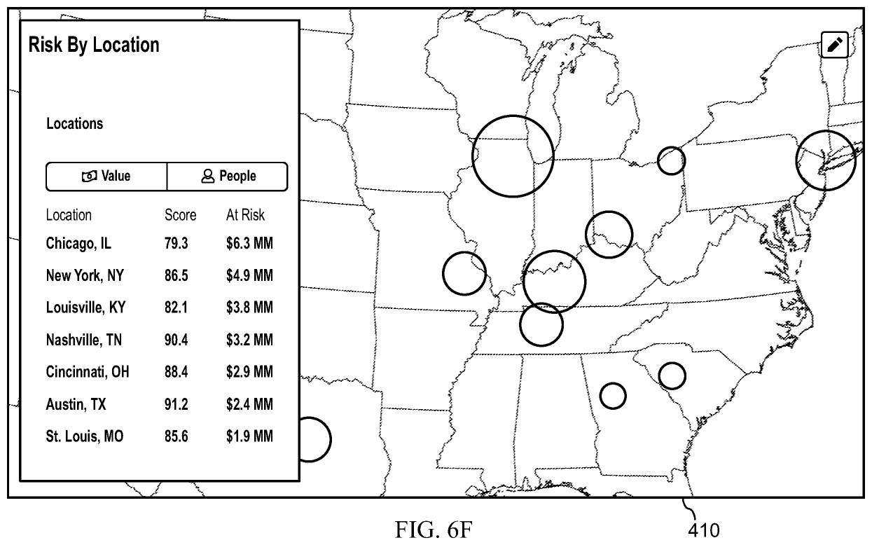

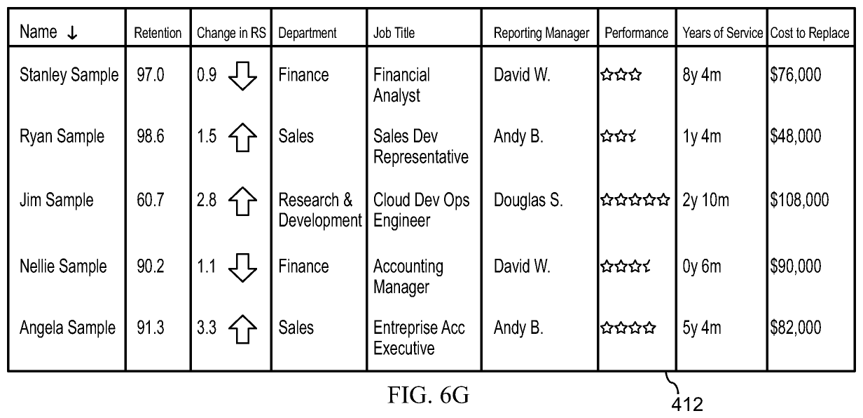

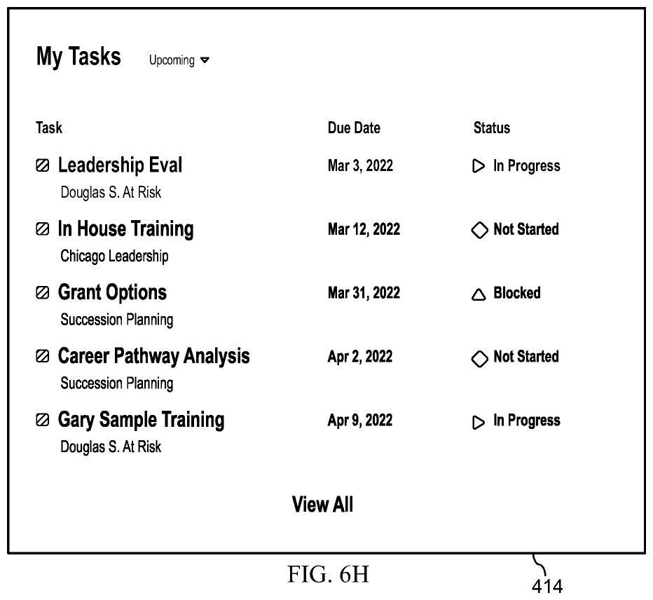

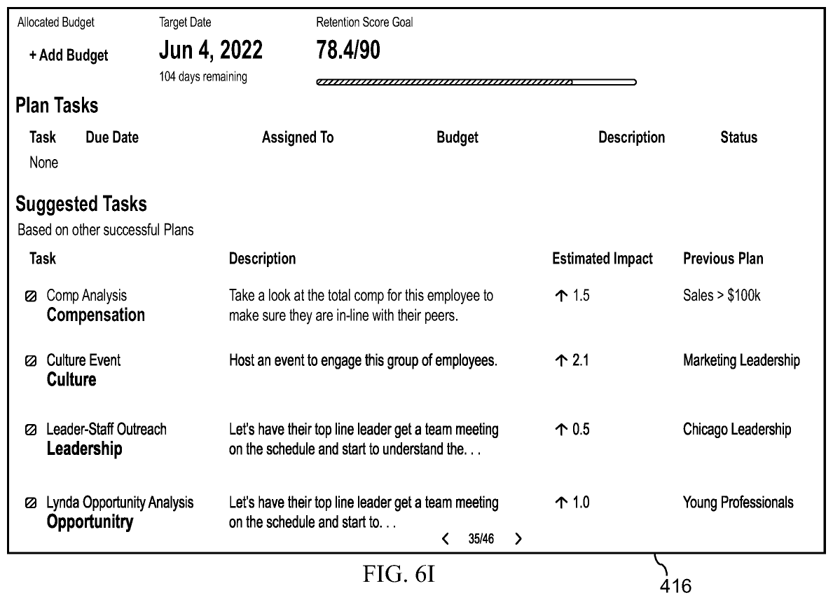

Using the retention metrics and other received information, the event server (100) may provide (208) a retention dashboard to user devices of users of the system. Examples of interfaces that may be provided as part of the retention dashboard are provided in FIGS. 6A through 6I, which are described in more detail below. As users interact with the retention dashboard, the event server (100) may provide (210) guidance for retention plans and retention tasks, which may include determining quantitative metrics that describe the impact of certain actions on employee retention (e.g., such as the effect on quantitative retention metrics if an employee were to receive a salary increase or promotion), providing tools for a user to create an action plan and assign tasks to other individuals, and providing users with notifications and alerts related to assigned tasks.

While FIG. 2 illustrates a set of high-level steps that may be performed by the system, FIGS. 3-5 provide additional examples of more detailed steps that may be performed during steps such as those of FIG. 2. For example, FIG. 3 is a flowchart of a set of steps that could be performed with a system to receive and organize content events. As has been described, the event server (100) may receive (300) event datasets via content channel webhooks and may receive (308) event datasets via content channel APIs, as that content is distributed to different channels for which tracking is configured, and recipients engage or interact with that content.

Due to the nature of web-based content and webhooks, it is almost assured that some number of received (300) webhook event datasets do not actually originate from legitimate employee engagement and are instead prompted by bot activity or other automated activity. This is a significant challenge, since many event tracking webhooks (106) will be URL based with attributes and parameters included or encoded within the URL (e.g., such as a unique employee identifier that associates the webhook with a particular employee that is passed as part of the webhook URL). As a result, when that webhook URL is requested and loaded by a bot or automated process instead of an employee client device, such a request will be indistinguishable from a request originating from a client device. As an example, where an organization distributes tracked content to all of its employee's by email, and those emails include embedded tracking pixels or other webhooks, that organization's security software (e.g., anti-spam, anti-virus, URL verification) may trigger those webhooks and create a number of false positive events before the email is actually even delivered to the recipient employee.

To resolve this issue, the event server may use an organization specific analytical function such as an artificial intelligence function, expert function, or other analytical function that is configured and/or trained to validate (301) and distinguish events prompted by automated activity from events prompted by actual employee engagement and interaction. As an example, a machine learning or neural network function may be configured and trained, based upon historic event data received from the organization's employees, and in some implementations based upon manual annotation and curation of that event data, in order to identify events prompted by automated activity.

In some implementations, this may include using event data associated with many different employees to identify automated activity (e.g., such as events indicating engagement with content moments after it is distributed, or events indicating engagement of the content by an abnormal number of employees within a brief window of time, each of which could be caused by security software scanning and verifying distributed email content before it is actually delivered to the recipient), and may also include manual annotation and creation of a training dataset based on that event activity to train an artificial intelligence to spot similar patterns.

In some implementations, this may include using expert functions that are preconfigured with rule sets for filtering out automated activity. For example, events may be discarded based on preconfigured rules and thresholds if they occur too quickly after distribution of the content, if an abnormal number of events from different employees occur simultaneously, or if the events occur on abnormal days or at abnormal times where employees are rarely engaging with content, such as during holidays or early morning hours. In some implementations, an expert function may be configured based upon information from the organization describing its information security policies and schedules that would cause automated events (e.g., such as nightly security scans, pre-scheduled content distributions, etc.).

Where an event cannot be validated (302) as legitimate employee engagement (e.g., using one or several analytical functions described above), the event may be discarded (304). Where the event is validated (302) as employee engagement, or where the event is received (308) as an API event, the system may identify (306) the associated employee. Identification (306) of the associated employee will vary based upon the content and source of an event dataset, but for example may include extracting a unique employee identifier from a URL of a webhook event (300) or selecting a unique employee identifier from an object or response dataset from API event (308). Based upon that employee identifier or other unique identifying data, the received (301, 308) event dataset may be associated with a single employee.

The event server (100) may also identify (310) any channels, tags, or other parameters associated with the event dataset that will influence how the event dataset is organized, and then may (312) add the event dataset to one or more-time indexed sequences of events for the employee. Time indexing (312) of events into sequences is advantageous in that it provides additional context for subsequent analysis. As an example, without time indexing (312) of events it may appear that a particular employee is highly engaged with content distributed by the organization. However, in the same scenario where the events can be seen in the sequence that they occurred and with reference to the time between occurrences, it may become apparent that the employee generally disregards content that is distributed by the organization, except that once a week they will spend a couple of minutes to quickly open and close all of the recently distributed content.

Identification (310) of tags, channels, or other important parameters contained in the event dataset may be important where the event server (100) is configured to analyze or handle events from different channels, or events having different tags, separately. As an example, in some implementations an organization may have one analytical function for determining (206) retention based upon events generated from engagement with email content, and a separate analytical function for determining (206) retention based upon events generated from engagement with an employee's news feed content (e.g., with those retention metrics being blended together and/or considered in mutual context when arriving at a final quantitative retention metric).

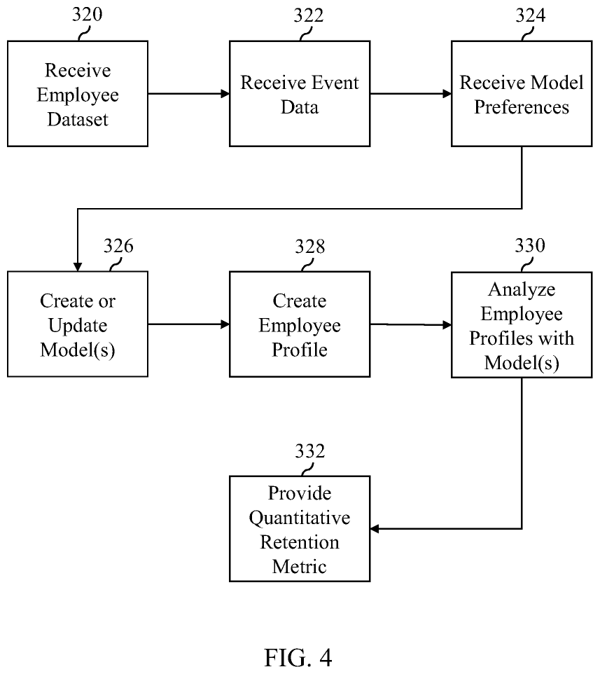

FIG. 4 is a flowchart of a set of steps that could be performed with a system to create and maintain one or more models for analyzing retention based on employee engagement events. Once implemented, and regularly thereafter, the system may receive (320) an employee dataset from the HRMS (112) that describes current employees, new employees, and employees that have resigned or been terminated. Information received (320) for each employee may include, for example, a unique employee identifier, name, position or role, group or subdivision, manager, hire date, salary, and other information. In some implementations, received (320) employee datasets may include records describing retention actions and events that have taken place with the employee, such as the date or description of the employee's most recent performance review, compensation analysis, promotion, teambuilding or organization culture building event, or other events that may influence employee content engagement and retention. Once implemented, the system may also receive (322) event datasets for current employees on an ongoing basis. The system may also receive (324) analytical model configurations or preferences from an administrator of the system, which may include identifying one or more different models that the system should create and maintain, and the characteristics of those models.

As an example of the above, one organization whose workforce is in fairly homogenous roles (e.g., substantially the entire workforce fills a software development or related position) may wish to have a single organizational model that is created based upon all of the received employee datasets and events (320, 322). On the other hand, a different organization may have two fairly distinct workforces (e.g., such as where 50% of their employees are in brick and mortar retail roles, and the other 50% of their employees are software development and technical support roles that innovate and support the retail locations), and so may wish to have a separate analytical model for each distinct workforce that is built based upon received (320, 322) employee and event data that corresponds to that workforce. In this manner, subsequent retention analysis of employees from each workforce may be performed by a more specialized model for that workforce.

With model preferences (324) and other inputs known or available, the event server (100) may then create (326) the applicable analytical functions or models, or where they have already been created, may update the analytical functions or models based upon newly received employee datasets (320) (e.g., which will influence the model as employees remain with the organization, and when employee resign or leave the organization, especially where the quantitative retention metrics for an employee do not align with their departure) and newly received (322) or newly relevant event data (e.g., event data for an unexpectedly departing employee may take on a new meaning after their departure, while newly received event data from employees having high quantitative retention metrics and remaining with the organization will reinforce the function or model's analysis).

In addition to creating (326) and maintaining the analytical models, the event server (100) may also create (328) an employee profile, for each employee, that is configured to be provided as input to the analytical model. An employee profile may contain employment information from the HRMS (112), such as position or role, group or subdivision, manager, hire date, salary, and other information, and may also contain one or several sequences of events that have been received and associated with that employee. The system may then analyze (330) each employee profile using one or more of the maintained (326) models or functions and provide (332) a quantitative retention metric that describes the likelihood of that employee departing from the organization. The quantitative retention metric may be, for example, a number of arbitrary scale that is provided as raw output from the analytic function (e.g., such as a confidence or probability metric), or may be a within a certain scale or range (e.g., between 1 and 100) based upon normalization of the output of the analytic function.

In implementations where the analytical models or functions are artificial intelligence (e.g., machine learning, neural network) functions, analysis (330) of an employee profile may include identifying patterns of employment information (e.g., salary, role, manager, etc.) and content engagement (e.g., based on received events) that are similar to historic data patterns from which the function is created (326), and then assigning a quantitative metric based on the extent of the similarity. As an example, suppose that the historic data from which the function is created (326) shows a strong pattern of departure for software developers, collaborating with a particular manager, with a salary less than $80,000 per year, and with low content engagement.

Analysis of an employee profile for an employee that is a software developer, works under that manager, has a salary of less than $80,000 per year, and exhibits low content engagement would provide (332) a quantitative retention metric suggesting a very high likelihood of departure during an upcoming time period (e.g., where the quantitative retention metric is normalized to a scale of 1 to 100, a retention metric of 50 may indicate a 50% chance that the employee will depart the organization during the time period in question). The particular time period may vary by implementation and may be user configured, but as an example may be between about four weeks and about four months. Continuing the same example, analysis of an employee profile for an employee that is a software developer, works under that manager, but has a salary of more than $80,000 per year, and exhibits moderate content engagement would provide (332) a quantitative retention metric suggesting a low likelihood of departure during an upcoming time period (e.g., a retention metric of 85, which may indicate a 15% chance that the employee will depart the organization during the time period in question).

Based on the example above, the value of receiving (320, 322) new employee datasets and event data on an ongoing basis becomes apparent, as departure of employees and retention of employees over a period of time each provide useful data points to reinforce and/or correct the evaluations made by the function.

There are a variety of actions that an organization can take to improve the likelihood that valued employees will remain with the organization. Examples include compensation analysis and adjustment, promotion or title change, team building activities, organization retreats, and other workplace culture activities, leadership meetings, outreach, and other leadership communication activities, opportunity and career planning analysis and outreach, role changes, team changes, managerial changes, location changes, and flexible work schedules.

Due to the unreliability and unavailability of data that is conventionally available and used for evaluation employee retention, actions taken to improve employee retention are often chosen based upon old or inaccurate data (e.g., such as subjective feedback from an employee during a performance review meeting that occurred 6 or more months ago), or are chosen based upon subjective determinations about the effect (e.g., positive or negative) and magnitude (e.g., minimal or substantial) of change that the action will have on employee retention.

Implementations of the disclosed technology allow users to create and manage retention plans for particular employees or groups of employees, including creating and assigning discrete tasks to other users for completion, tracking status of assigned tasks and overall effect of the retention plan, and providing notifications and alerts to users when tasks are assigned, completed, or approaching a due date for completion. As has been described, implementations of the disclosed system also provide quantitative metrics that describe the effect of particular tasks of a retention plan on employee retention.

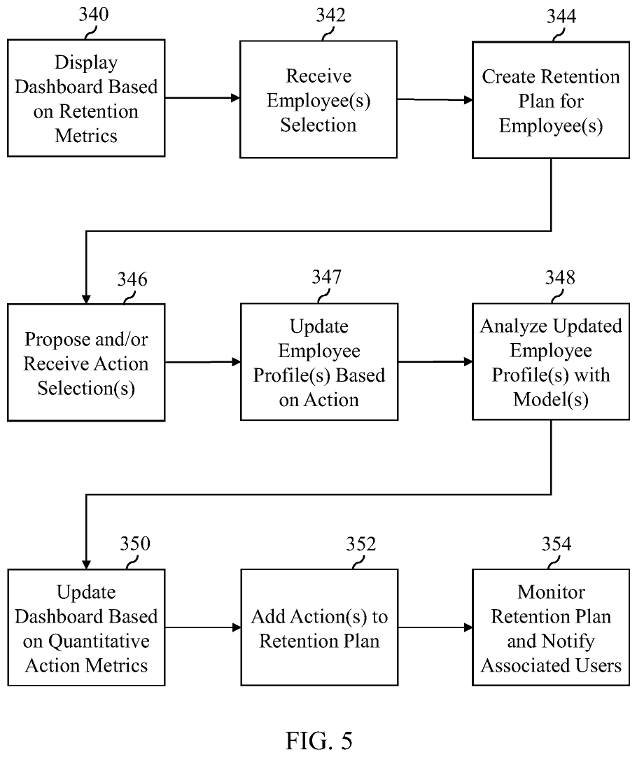

As a further example of the above, FIG. 5 is a flowchart of a set of steps that could be performed with a system to create and manage employee retention plans. When displaying (340) the retention dashboard based on quantitative retention metrics and employee information for employees of an organization, the dashboard may provide users with tools for creating, configuring, and managing retention plans. When using those tools, the event server (100) may receive (342) selections for one or more employees to be targeted by the retention plan and may group those employees together into a newly created (344) retention plan. While part of a retention plan, employee information and quantitative metrics may be displayed in separate focus windows or interfaces provided as part of the dashboard so that individuals in the retention plan can be viewed independently of the organization's other employees or groups.

The system may also propose (346) or receive one or more action selections from a pre-configured list of retention actions that have been configured in the system and displayed as selectable options via the dashboard. Pre-configured retention actions may include generic or global actions available for every organization, custom actions configured by or for particular organizations, or both. Pre-configured retention actions may include both a type of action and a magnitude of action, where applicable (e.g., salary increase may be a type of action, with a flat dollar amount or percentage of increase being the applicable magnitude).

When automatically proposing (346) or receiving actions to be added to the retention plan, the event server (100) may be configured to provide additional quantitative metrics that are predictive of the impact that a particular action will have if executed as part of a retention plan. In this manner, the system may automatically evaluate a plurality of available actions and propose (346) a subset of actions that are recommended based on these quantitative action effect metrics and allow the user to select from those proposed (346) actions. As another example, the system may also responsively evaluate and provide quantitative action effect metrics where a user selects (346) one or more actions that are not proposed by the system, such that the user may evaluate the impact of their selected actions before confirming and adding (352) the actions to the retention plan. In either case, as these action effect metrics become available, the system may update (350) the retention dashboard to display the new quantitative metrics and provide controls for the user to confirm, select, or add (352) particular actions to the retention plan.

In order to determine quantitative action effect metrics for an employee or group of employees, the system may updated (347) the current employee profile for the affected employees based on the action that is being evaluated, and may analyze (348) the updated employee profiles using the same models or functions used to provide the initial quantitative retention metrics (e.g., such as described in the context of FIG. 4, particularly in relation to analyzing profiles (330) and providing (332) those metrics). As an example of the above, after viewing a displayed (340) dashboard showing quantitative retention metrics for some or all of an organization's employees, a user may select (342) the ten employees with the lowest retention metrics and create (344) a retention plan to associate the selected employees with.

The event server (100) may identify any pre-configured retention actions that are available for the group (e.g., some retention actions may only be available for employees in certain roles or positions, or certain geographic locations), and may update (347) each employee's profile based on each available action and then analyze (348) each updated profile with the same models or functions used to initially evaluate the employees retention metrics.

As further example of the above, suppose that an employee profile created (328) for one employee in the retention plan describes a junior software developer, with a salary that is about 10% below market, that has never participated in an opportunity or career development analysis, and that shows low engagement with content. The system may analyze (330) that employee profile using an organization's custom, organization specific retention function (e.g., a machine learning, neural network, expert, or other function that is trained or configured based on that organization's other employee datasets and event datasets) to determine that a scaled and/or normalized quantitative retention metric for the employee is 50 out of 100 (e.g., indicating that the employee has about a 50% chance of departing the company within the next 3 months).

When a retention plan is later created (344) to include the most at-risk employees at the organization, the above employee is selected (342) and included in the retention plan. The event server (100) then identifies all the retention actions that have been configured as available for that employee, and for each available retention action the event server (100) updates (347) the employee's original profile to include or reflect the performance of that retention action, and analyzes (348) each updated profile with the organization specific retention function that was previously used to determine a new quantitative retention metric for the employee that reflects the performance of that retention actions. Continuing the example above, the event server (100) identifies five available retention actions for the selected (342) exemplary employee, creates five separate updated (347) employee profiles that reflect performance of each retention action for the employee, and analyzes (348) the updated employee profiles to provide five quantitative retention metrics that correspond to the actions, and display (350) those action effect metrics via the dashboard (e.g., Table 1 below provides an example of information that may be determined and/or displayed related to this example).

TABLE 1
Quantitative retention metrics (“QRM”) based on action effect

| Action | Current | Updated | QRM | Change |
|---|---|---|---|---|
| Salary Increase to Market | −10% | 0% | 48.4 | −1.6 |
| Salary Increase Above Market | −10% | 5% | 54.8 | +4.8 |
| Salary Increase Above Market | −10% | 10% | 54.9 | +4.9 |
| Promotion | Junior | Senior | 65.2 | +15.2 |
| Career Development Meeting | n/a | Current | 59.5 | +9.5 |
| Stay Interview | n/a | Current | 53.5 | +3.5 |
| All Net-Positive Actions | n/a | n/a | 79.8 | +29.8 |

While various subjective conclusions may be made by an observer of the information in this example (e.g., salary is a concern for the employee, but the primary concerns seems to be recognition, future career growth, and perception within the organization), that type of guesswork is not necessary and a user may instead select the most beneficial or desirable actions for the employee's retention plan based on the change in quantitative metrics. As an example, without the benefit of the predictive quantitative metrics, a user might choose to increase the employee's salary to market levels based on a subjective conclusion that it will help with retaining the employee (e.g., whereas the quantitative metrics indicate that a market-level salary increase may actually upset the employee and harm retention). As another example, without predictive metrics a user may choose to increase the employee's salary to 10% above market level (e.g., despite the quantitative metrics indicating that a salary increase to 5% above market level will achieve substantially the same result with respect to impact on retention).

In some implementations, the system may perform multi-action predictions in an analogous manner as single-action predictions are performed. For example, with reference to Table 1, the “All Net-Positive Actions” row may be determined by creating an updated (347) employee profile that reflects all of a 5% salary increase, promotion, career development meeting, and stay interview, and may analyze (348) that updated profile to determine a quantitative metric for the net effect on retention of performing all of those actions.

With available actions and any action-effect prediction metrics displayed (350) via the dashboard, the system may add (352) one or more of those actions to the employee's retention plan based on selections or confirmations input by the user, and then may begin to monitor (354) that retention plan moving forward. Monitoring (354) of retention plans may include providing alerts and notifications to users associated with the retention plan (e.g., where a particular manager is assigned an action related to conducting an employee development meeting with the employee, that manager may receive electronic notifications and alerts such as email or text messages, or may be displayed a focused window or other interface upon subsequently accessing the retention dashboard). Notifications may occur when actions are created or assigned, when actions are completed, when actions are overdue or approaching a deadline, and when actions are initiated, for example.

FIGS. 6A through 6I illustrate examples of tools and interfaces that may be provided by the retention dashboard. FIG. 6A is a screenshot of a global retention tracking interface (400) that displays a timeline of average retention metrics for different employee groups (e.g., an “Average” group is based upon all employees, while a “West” group is a sub-group of employees associated with the organization's western region or group), a summary of the number of employee considered at-risk based on retention metrics (e.g., based upon a configured threshold, such as any retention metric below 70 on a normalized scale between 1 and 100), a summary of current average retention score and change in average retention score over a prior time period, and a summary of the cost of replacing all at-risk employees (e.g., where per-employee replacement cost is provided to the system by the HRMS (112) or otherwise received or determined).

FIGS. 6B and 6C show screenshots of a retention plan tracking interface (402) and a group retention tracking interface (404) respectively, each of which may be displayed by the retention dashboard. The plan tracking interface (402) shows a summary of all current retention plans that have been created, their current average retention score of employees associated with the retention plan, the count of employees associated with the retention plan, and a target date or deadline by which the plan must be completed. The group tracking interface (404) shows a summary of all sub-groups of employees that have been created, where sub-groups may be the same or different sub-groups than those created and associated with a retention plan. Displayed information may include the group's current average retention score, the change in retention score for the group over the last 30 days, and the count of employees associated with the group.

FIG. 6D is a screenshot of a retention risk summary interface (406). The risk summary interface (406) includes descriptions and visualizations for a group of employees, including total counts and percentages of employees in the group that are at high, medium, and low risk levels based on quantitative retention metrics, and a summary of custom or field based (e.g., based on fields present in employee profiles and information received from the HRMS (112), such as age, gender, job role, department, manager, and so on) sub-groups that include the highest number or percentage of high risk/at-risk employees.

FIG. 6E is a screenshot of a turnover rate interface (408). The turnover interface (408) may be displayed by the retention dashboard, and may include a summary of annual, monthly, or other time-period based turnover rate, visualizations of total departures over a time period (e.g., including indications of whether departure was voluntary or involuntary), and a timeline visually illustrating departures by month, week, or other time period.

FIG. 6F is a screenshot of a geographical retention risk interface (410). The geographical interface (410) may be displayed by the retention dashboard, and may include a visualization of one or more countries, regions, or other geographic locations where a particular organizations employees are located, may include a list of locations (e.g., where the organization's physical offices and workplaces are located) and a summary of average retention score and cost of replacement for high risk/at-risk employees at those locations, and may include visual indicators placed on the map visualization that correspond to the summarized locations and magnitude of retention score and/or cost of replacement associated with those locations.

FIG. 6G is a screenshot of an employee interface (412). The employee interface (412) may be displayed by the retention dashboard, and may include a list of all employees whose content engagement and retention are tracked by the system, and for each tracked employee may include additional information such as current retention score, change in retention score over last 30 days (e.g., or other configured time period), the department or group that the employee is part of within the organization, a job title for the employee, a reporting manager for the employee, a performance rating for the employee (e.g., if received from the HRMS (112) or otherwise received or determined), a total years of service for the employee, and a cost to replace the employee if they are not retained, for example.

FIG. 6H is a screenshot of an assigned task interface (414). The task interface (414) may be displayed by the retention dashboard, either as a single window or interface amongst several, or may be displayed as a pop-up, focused, or isolated interface as part of a notification to associated users. The task interface (414) may include a list of retention plan actions that a user of the retention dashboard is associated with (e.g., as a creator, as an assignee of an action), and may include for each retention plan action a description of the associated retention plan, a description of the retention action (e.g., leadership evaluation, compensation analysis, training), a due date for the task, and a current status of the task, for example.

FIG. 6I is a screenshot of a retention plan management interface (416). The plan management interface (416) may be displayed by the retention dashboard when creating retention plans and assigning tasks to retention plans. The plan management interface (416) may include a summary of tasks currently assigned to the retention plan (e.g., “None” in the example of FIG. 6I) and may provide controls to review and add actions to the retention plan. As an example, this may include a list of suggested or available tasks or actions, and for each task or action a description of the action, a type or category of the action (e.g., Compensation, Culture, Leadership, Opportunity), a detailed description of the action (e.g., such as might be used as instructions by a user that is assigned to complete the task), an estimated impact for performing the action (e.g., based upon action effect metrics, as described in the context of FIG. 5 and particularly in relation to updating (347) employee profiles to reflect actions and analyzing (348) the updated profiles), and an example of a previous action plan that the action was assigned to and provided positive results.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

We claim:

1. A system for tracking personnel engagement with distributed content, comprising:
one or more event servers configured to receive one or more behavioral data related to one or more employees and describing one or more employee actions related to an employer's information technology system;
one or more HRMS (Human Resource Management System) servers communicatively coupled to the one or more event servers and configured to store one or more HR data related to the one or more employees;
a content distribution system configured to distribute content to at least some of the one or more employees, and further configured to detect at least one of the one or more employee actions in relation to the content and to communicate the at least one of the one or more employee actions to the one or more event servers; and
a retention dashboard configured to present one or more quantitative metrics related to the one or more behavioral data to one or more user devices.

2. The system of claim 1, wherein the one or more event servers comprise one or more of: physical, virtual, cloud, or other servers.

3. The system of claim 1, wherein the retention dashboard is created by the employer's information technology system.

4. The system of claim 1, wherein the one or more user devices comprise one or more of: a smartphone; a computer; a tablet.

5. The system of claim 1, wherein the one or more HRMS servers comprise the employer's information technology system.

6. The system of claim 1, wherein the one or more HR data comprise one or more of: personal information, name, age, gender, demographic information, employment information, position or role, group or subdivision, manager, hire date, salary, cost of replacement, status information, an indication that the employee has resigned or was terminated, past records of engagement with the employee, dates and results of reviews, stay interviews, exit interviews.

7. The system of claim 1, wherein the content comprises one or more of: an application, a platform, a service, software.

8. The system of claim 1, wherein the one or more behavioral data comprise one or more of: one or more data from one or more web-based content channels; one or more data from one or more events tracking APIs (application programming interfaces); one or more data from one or more event tracking webhooks.

9. A method for tracking employee retention data, comprising:
configuring one or more content for distribution and tracking of one or more employee actions;
receiving the one or more employee actions;
organizing the received one or more employee actions;
configuring the one or more employee actions to be analyzed by one or more retention modules; and
determining one or more retention metrics for one or more employees related to the one or more employee actions.

10. The method of claim 9, further comprising providing one or retention dashboards to one or more users, the one or more retention dashboards configured to illustrate the one or more retention metrics.

11. The method of claim 10, further comprising providing one or more retention guidances related to the one or more employees.

12. The method of claim 9, wherein the one or more employee action comprise one or more of: events indicating a piece of content was opened or accessed, events indicating the extent to which sub-content or sub-portions of a greater body of content are viewed or interacted with, the extent or depth to which a user scrolled downwards to view a sequence of sub-portions of content provided by a web or application based content feed or wall, user interactions with sub-portions of content such as clicking a menu link to jump to a particular sub portion, clicking a software control to expand and/or view further information on a sub portion, clicking a “thumbs up” button or other button to respond to the content, submitting a comment or other message in response to the content.

13. The method of claim 9, further comprising using the received one or more received employee actions to train a machine learning model used for predicting the one or more retention metrics.

14. The method of claim 9, wherein the determining comprises analyzing the one or more employee actions with a trained machine learning model used for predicting one or more employee retention metrics.

15. The method of claim 9, wherein the one or more retention modules comprise one or more of: artificial intelligence; one or more machine learning models; a neural network.

16. The method of claim 9, wherein the one or more retention metrics comprise a prediction of retention if an employee were to receive a salary increase or promotion.

17. A method for tracking employee retention data, comprising:
receiving one or more webhook events related to one or more employees;
validating the one or more webhook events;
receiving one or more API (application programming interface) events related to the one or more employees;
identifying a respective of the one or more employees associated with the one or more webhook events and the one or more API events; and
adding the one or more webhook events and the one or more API events to a respective one of one or more indexed sequences of events associated with the one or more employees.

18. The method of claim 17, wherein the validating is performed with one or more of: artificial intelligence; machine learning; a neural network; a machine learning model or neural network function trained on historic event data received from an organization's employees; manual annotation or curation of historic event data.

19. The method of claim 17, further comprising discarding one or more webhook events that are not related to the one or more employees.

20. The method of claim 17, further comprising;
identifying one or more data tags associated with the one or more webhook events and/or the one or more API events; and
adding the one or more data tags to the respective one of the one or more indexed sequences of events.
